(19) United States
(12) Patent Application Publication
(10) Pub. No.: US 2010/0174899 A1
(43) Pub. Date: Jul. 8, 2010

(54) DATA DISTRIBUTION SYSTEM, KEY MANAGEMENT DEVICE, AND KEY MANAGEMENT METHOD

(75) Inventors: Xiping LIN, Yokohama (JP); Daiki NOZUE, Fujisawa (JP); Shinichiro SAITO, Kawasaki (JP)

Correspondence Address: MATTINGLY & MALUR, P.C., 1800 DIAGONAL ROAD, SUITE 370, ALEXANDRIA, VA, 22314, US

(73) Assignee: HITACHI, LTD., Tokyo (JP)

(21) Appl. No.: 12/623,474

(22) Filed: Nov. 23, 2009

(30) Foreign Application Priority Data
Jan. 7, 2009 (JP) 2009-001589

(51) Int. Cl. H04L 29/06; H04L 9/08

(52) U.S. Cl. 713/153; 380/279

(57) ABSTRACT

Receiving terminals joining a multicast group are divided into sub groups and rekeying is performed only on the sub group which one of the receiving terminals has left. An encryption key management system having an encryption method is provided in which a multicast server is connected via an IP network, a seed node carries out encryption multicast communications among receiving terminals by using an encryption key, the receiving terminals are properly divided into the sub groups, the single encryption key is used for data distribution of the multicast server, and the number of decoding keys is equal to the number of divided sub groups.

### CLAIM OF PRIORITY

The present application claims priority from Japanese patent application serial no. 2009-001589, filed on Jan. 7, 2009, the content of which is hereby incorporated by reference into this application.

### BACKGROUND OF THE INVENTION

The present invention relates to a data distribution system, a key management device, and a key management method and particularly relates to a data distribution system, a key management device, and a key management method which can efficiently carry out multicast communications.

As a technique for sharing the same information between terminals connected to a network, multicasting is available. In multicast communications, terminals sharing information constitute a group and the same information can be shared in the group by broadcast communications. For concealing information in multicast communications from terminals outside the group, encryption is effectively used. In other words, a transmitter in multicast communications encrypts information by using an encryption key. A receiver in multicast communications decodes received information by using a decoding key. The encryption key and the decoding key have to be shared only in the multicast group and have to be concealed from terminals outside the group.

In such encrypted multicast communications, when a terminal belonging to a group leaves the group, it is necessary to change at least the decoding key. This is because, if the decoding key is not changed, the terminal having left the group and secretly intercepted information can decode the information. In other words, it is not possible to satisfy the attribute of multicast communications in which information is shared only by terminals belonging to the group. The following will examine the case where a multicast server distributes paid information through multicast communications to a large number of multicast client terminals subordinate to the server. In this case, a terminal having left the group can illegally intercept information without being charged for the information.

In multicast communications of the related art, when a receiving terminal leaves a multicast group, rekeying is necessary for all receiving terminals remaining in the multicast group. In this case, rekeying means reissuing of a key. As the size of a multicast group increases, the traffic of rekeying may emerge as a problem.

In a key management system described in Japanese Patent Laid-Open No. 2006-245663, a multicast group is divided into several sub groups each of which has a representative receiving terminal. The representative receiving terminal carries out communications between a multicast server and receiving terminals in the sub group. The multicast server delivers a decoding key only to the representative receiving terminals, and each of the representative receiving terminals delivers the decoding key to the receiving terminals in the sub group.

### SUMMARY OF THE INVENTION

In the multicast communications key management system described in Japanese Patent Laid-Open No. 2006-245663, traffic for updating a key can be reduced. However, if one of a large number of receiving terminals leaves the multicast group, rekeying is necessary for all the receiving terminals remaining in the multicast group. Further, the number of receiving terminals manageable under the representative terminal is limited.

The present invention can freely create a sub group without providing a representative terminal and perform rekeying only for a sub group which a receiving terminal has left.

Further, the present invention provides a method which can create a sub group freely not depending upon the positions of multicast receiving terminals.

The foregoing problem can be solved by a data distribution system including: a distribution server that distributes data; a node that encrypts the data from the distribution server and transmits the data to plural receiving terminals; and a key management device connected to the node to manage an encryption key of the node and decoding keys of the plural receiving terminals, wherein the key management device allocates each of the receiving terminals to one of plural sub groups and allocates the decoding keys to the respective sub groups, and the key management device changes, when receiving a leave notification from a first receiving terminal, the encryption key and the decoding key of a first sub group where the first receiving terminal belongs, and transmits the encryption key and the decoding key to the node and the other receiving terminals of the first sub group.

Further, the foregoing problem can be solved by a key management device connected to a distribution server that distributes data and a node that encrypts the data from the distribution server and transmits the data to plural receiving terminals, the key management device managing an encryption key of the node and the decoding keys of the plural receiving terminals, wherein the key management device allocates each of the receiving terminals to one of plural sub groups and allocates the decoding keys to the respective sub groups, and the key management device changes, when receiving a leave notification from a first receiving terminal, the encryption key and a decoding key of a first sub group where the first receiving terminal belongs, and transmits the encryption key and the decoding key to the node and the other receiving terminals of the first sub group.

Moreover, the foregoing problem can be solved by a key management method including the steps of: allocating each of the receiving terminals to one of plural sub groups; allocating the decoding keys to the respective sub groups; changing the encryption key when receiving a leave notification from a first receiving terminal; changing a decoding key of a first sub group where the first receiving terminal belongs; and transmitting the changed encryption key to the node.

The encryption key management device includes: a sub group determining section that divides the receiving terminals belonging to the multicast group into the sub groups; a key management section that manages the encryption key for each group and manages the decoding keys for the sub groups for each group; a key generating section that generates and updates the decoding keys and changes the encryption key; a table management section that matches group information determined by a method of determining the sub groups and the key information of the key management section and manages the information; and an information transmitting/receiving section that receives a message and distributes a key.

In an encryption key management method, the seed node includes: an encryption section that encrypts multicast distribution data; an encryption key management section that matches and manages the multicast group and the encryption key; and an information transmitting/receiving section that distributes the encrypted distribution data and receives messages for joining and leaving the multicast group.

The receiving terminals are divided into the multicast group and the sub groups in the multicast group. The multicast group is identified and managed by an IP address. The IP address is a multicast address. Multicast with a destination address of 239.0.0.1 is handled as a multicast group 239.0.0.1.

In the encryption method, the encryption key for encryption and the decoding keys for decoding encrypted data are generated and updated by the key generating section of the key management device. It is assumed that there are n sub groups. Data to be distributed from the multicast server is denoted as M. Assuming that M is a numeric value, prime numbers K1, K2, . . . , Kn larger than M are obtained. In the case of large data, the data may be divided into pieces of proper sizes and one of the divided pieces of data may be processed as M as will be described below. The encryption key is expressed as A=K1*K2* . . . *Kn, the decoding key of a sub group 1 is denoted as K1, the decoding key of a sub group 2 is denoted as K2, and the decoding key of a sub group n is denoted as Kn. The number of decoding keys is equal to the number of sub groups.

Encryption is performed according to X=M+A where X represents cipher text.

The cipher text is decoded with a remainder obtained by dividing the cipher text X by the decoding key. In the case of the receiving terminal belonging to the sub group 1, the cipher text can be decoded as expressed in (equation 1).

X(mod K1)=M(mod K1)+A(mod K1)=M(mod K1)=M (equation 1)

where mod is a mathematical symbol indicating a remainder and mod K1 is a remainder obtained by dividing A by K1. In a modification of the equation, since A=K1* . . . *Kn is established, a remainder obtained by dividing A by K1 is 0. Further, since M is smaller than K1, a remainder obtained by dividing M by K1 is M.

When a member of the sub group 2 leaves the sub group 2, the decoding key of the sub group 2 is changed to K2′ and the encryption key is A′=K1*K2′* . . . *Kn. Cipher text X′ is X′=M+A′. The new decoding key K2′ can be used but the former decoding key K2 cannot be used. Actually, in a modification of the equation, A′ cannot be divided by K2 and thus the cipher text cannot be decoded as expressed below:

X′(mod K2′)=M(mod K2′)+A′(mod K2′)=M(mod K2′)=M (equation 2)

X′(mod K2)=M(mod K2)+A′(mod K2)=M+A′(mod K2)≠M (equation 3)

Thus the receiving terminal which has left the sub group cannot decode the cipher text by using the former decoding key K2.

Further, even when the decoding key is changed from A to A′, the sub group 1 is not affected by rekeying as expressed in (equation 4).

X′(mod K1)=M(mod K1)+A′(mod K1)=M(mod K1)=M (equation 4)

Practically X=M+A can only achieve weak encryption and stronger encryption can be achieved by X=M+f(A) by using a polynomial equation (equation 5) having no constant terms for the encryption key A as expressed below:

f(A)=an·Ân+an−1·Â(n−1)+ . . . +a1·A (equation 5)

where a coefficient ai (i=1, 2, . . . , n−1, n) is generated by a random number. The encryption may be combined with existing data encryption standard (DES, FIPS 46) or advanced encryption standard (AES, FIPS 197) to achieve stronger encryption. In other words, the cipher text X is further encrypted by DES or AES and then is distributed. In the equation, “̂” represents an exponentiation and Ân represents Aⁿ.

According to embodiments of the present invention, a key is updated only for a changed sub group, thereby reducing traffic for updating the key. Further, it is possible to efficiently multicast an encrypted broadcast message.

### BRIEF DESCRIPTION OF THE DRAWINGS

FIG. 1 is a hardware block diagram showing a multicast network;

FIG. 2 is a function block diagram showing a seed node and an encryption key management device;

FIG. 3 is an explanatory drawing showing an encryption key management table;

FIG. 4 is an explanatory drawing showing an encryption key/decoding key management table;

FIG. 5 is a sequence diagram showing the creation of a new sub group among a receiving terminal, a multicast node, the seed node, the encryption key management device, and a multicast server;

FIG. 6 is a sequence diagram showing the participation of a new receiving terminal, among the receiving terminal, the multicast node, the seed node, the encryption key management device, and the multicast server;

FIG. 7 is a flowchart showing the participation of a new receiving terminal of the encryption key management device;

FIG. 8 is a sequence diagram showing the separation of the receiving terminal, among the receiving terminal, the multicast node, the seed node, the encryption key management device, and the multicast server;

FIG. 9 is a sequence diagram showing further deletion of a sub group, among the receiving terminal, the multicast node, the seed node, the encryption key management device, and the multicast server;

FIG. 10 is a flowchart showing the separation of the receiving terminal of the encryption key management device;

FIG. 11 is a hardware block diagram showing a multicast network; and

FIG. 12 is a sequence diagram showing a multicast network.

### DETAILED DESCRIPTION OF THE INVENTION

The following will specifically describe modes by using embodiments with reference to the accompanying drawings. Substantially the same parts are indicated by the same reference numerals and the explanation thereof is not repeated.

### First Embodiment

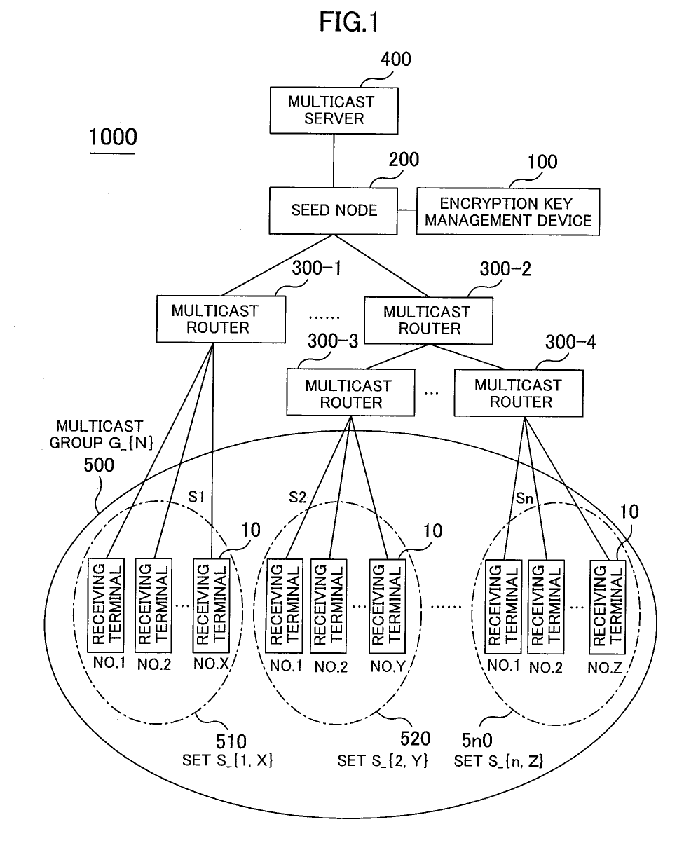

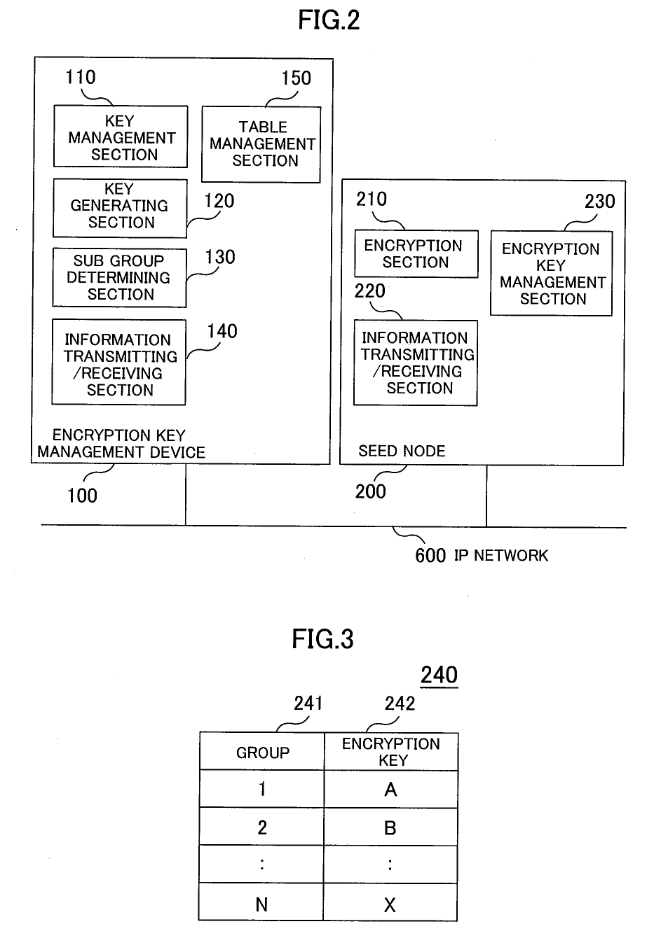

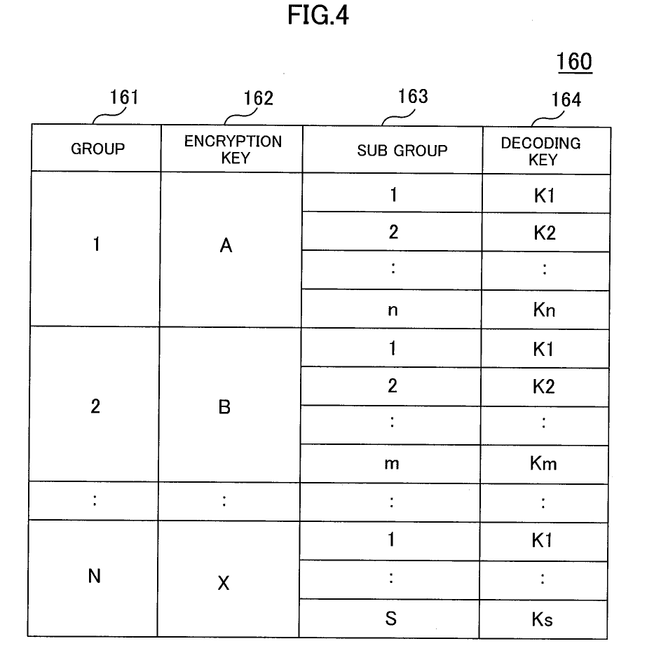

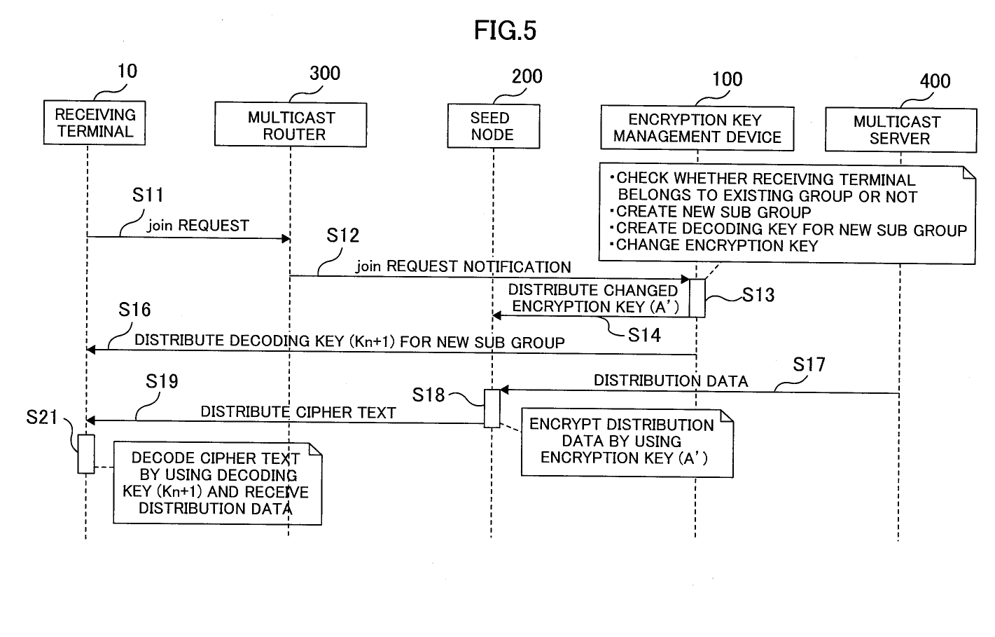

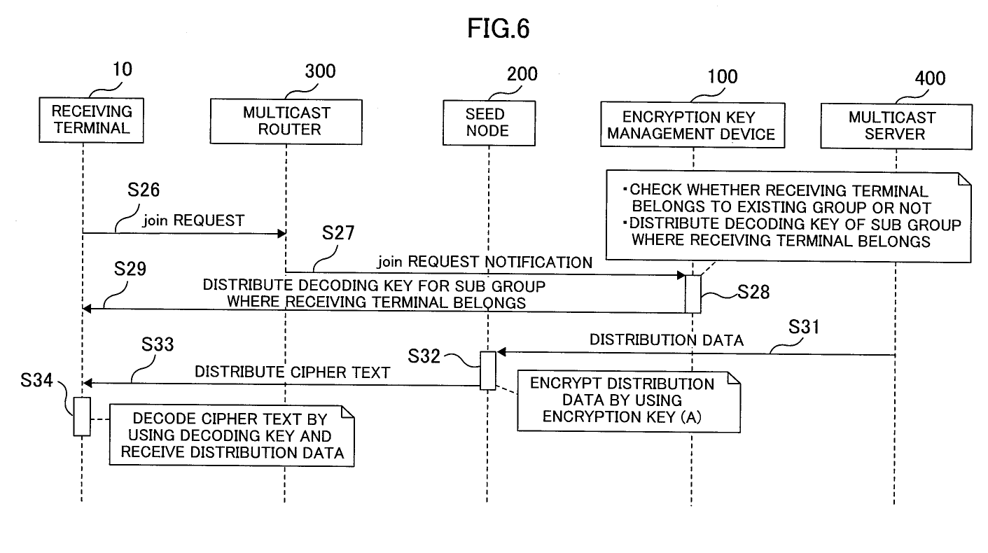

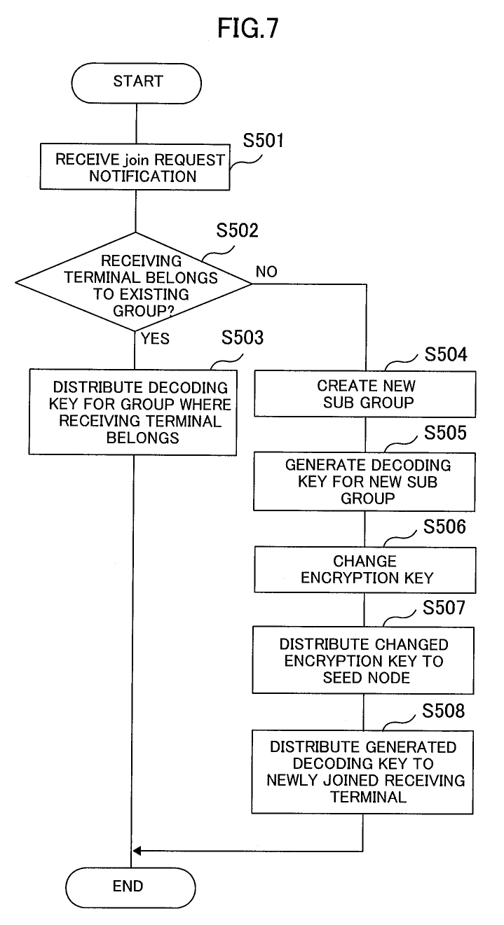

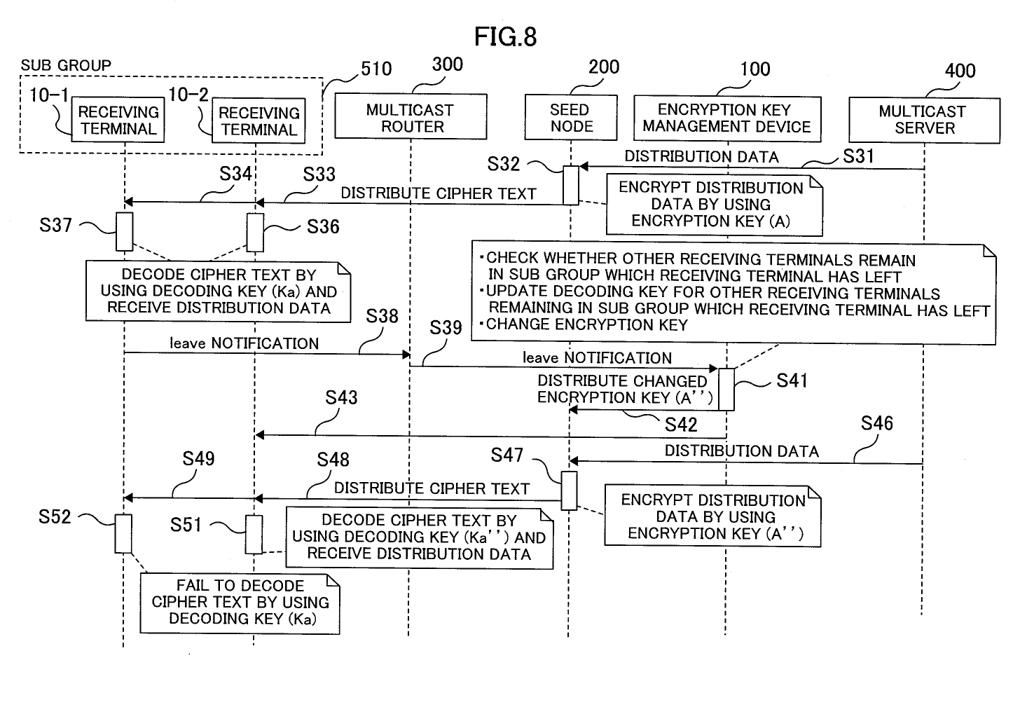

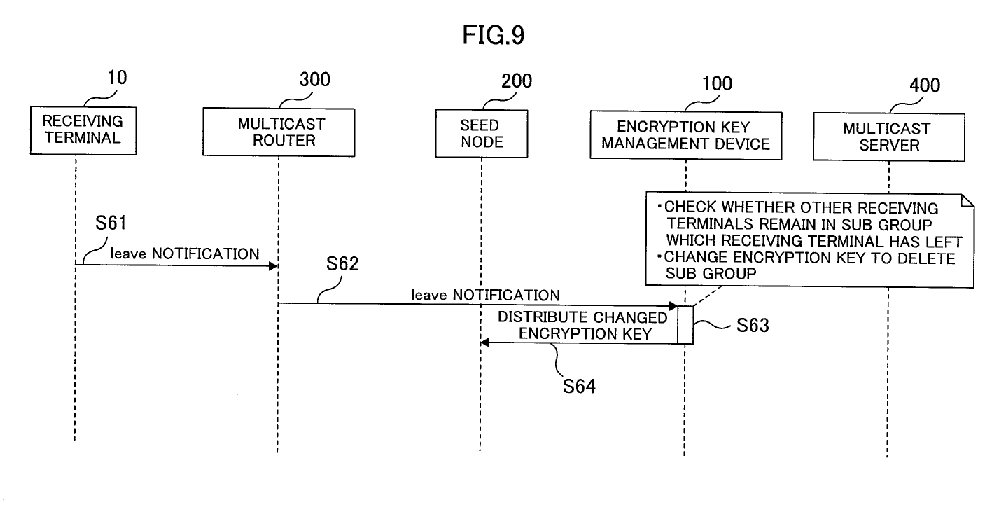

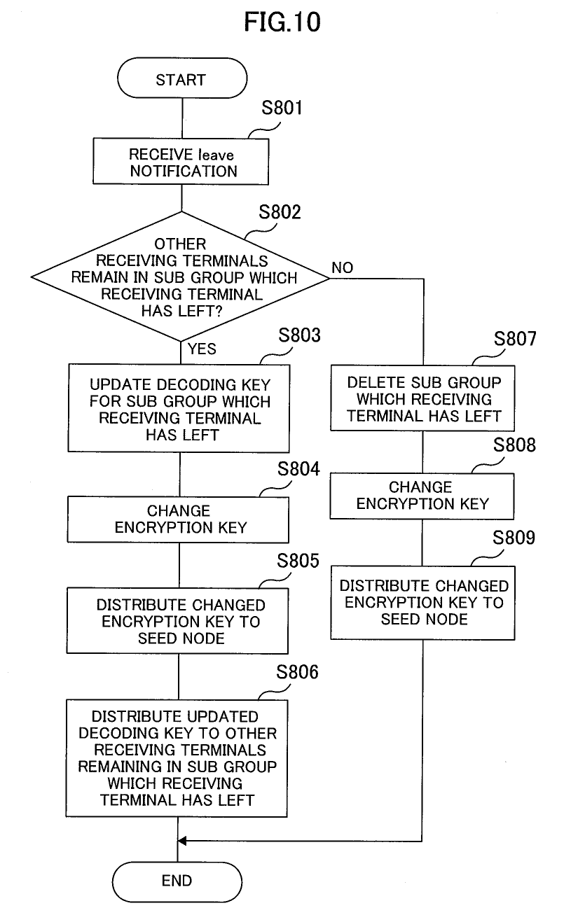

Referring to FIGS. 1 to 10, a first embodiment will be described below. FIG. 1 is a hardware block diagram showing a multicast network. FIG. 2 is a function block diagram showing a seed node and an encryption key management device. FIG. 3 is an explanatory drawing showing an encryption key management table. FIG. 4 is an explanatory drawing showing an encryption key/decoding key management table. FIG. 5 is a sequence diagram showing the creation of a new sub group among a receiving terminal, a multicast node, the seed node, the encryption key management device, and a multicast server. FIG. 6 is a sequence diagram showing the participation of a new receiving terminal, among the receiving terminal, the multicast node, the seed node, the encryption key management device, and the multicast server. FIG. 7 is a flowchart showing the participation of a new receiving terminal of the encryption key management device. FIG. 8 is a sequence diagram showing the separation of the receiving terminal, among the receiving terminal, the multicast node, the seed node, the encryption key management device, and the multicast server. FIG. 9 is a sequence diagram showing further deletion of a sub group, among the receiving terminal, the multicast node, the seed node, the encryption key management device, and the multicast server. FIG. 10 is a flowchart showing the separation of the receiving terminal of the encryption key management device.

In FIG. 1, a multicast network 1000 is made up of a multicast server 400, a seed node 200, an encryption key management device 100, four multicast routers 300, and plural receiving terminals 10. The plural receiving terminals 10 are each included in one of set S_{1, X} 510, set S_{2, Y} 520, . . . , and set S_{n, Z} 5n0 and the receiving terminals 10 constitute a multicast group G_{N} 500 as a whole. The seed node 200, the encryption key management device 100, and the four multicast routers 300 are connected via an IP network 600.

The multicast server 400 distributes data to the receiving terminals 10 by multicasting. The seed node 200 manages the multicast group in cooperation with the key management device 100. The key management device 100 manages an encryption key and decoding keys in the multicast group. The multicast routers 300 distribute data to the plural receiving terminals 10 by multicasting.

In the multicast group, clusters defining the trunk of a tree as sub groups have cluster heads sequentially numbered from group number 1 and cluster members are sequentially numbered from member number 1 such that the members can be identified. In other words, the multicast group G_{N} 500 is divided by the sub groups S_{1, X} 510, S_{2, Y} 520, . . . , and S (n, Z) 5n0 as follows: G_{N}=(S_{1, X}, S_{2, Y}, . . . , S_(n, Z))

Referring to FIG. 2, the following will describe the schematic configuration of the key management device and the seed node. In FIG. 2, the key management device 100 is connected to the seed node 200 via the IP network 600.

The key management device 100 is made up of a key management section 110, a key generating section 120, a sub group determining section 130, a table management section 150, and an information transmitting/receiving section 140. The seed node 200 is made up of an encryption section 210 for multicast data, an encryption key management section 230, and an information transmitting/receiving section 220.

In the key management device 100, the key management section 110 registers, updates, and deletes an encryption key provided for each multicast group in the table management section 150 and registers, updates, and deletes, for each group, decoding keys provided for the respective sub groups in the group. The key generating section 120 changes, generates, and updates key information when receiving a request for a change, generation, and updating of the key information from the key management section 110. The sub group determining section 130 creates, updates, and deletes the sub groups when receiving a method of determining the sub groups and join and leave requests of Internet group management protocol (IGMP) from the receiving terminals through the information transmitting/receiving section 140. The table management section 150 performs registration, updating, and deletion by matching group information from the sub group determining section 130 and key information from the key management section 110. The information transmitting/receiving section 140 receives messages and distributes keys.

In the seed node 200, the encryption section 210 encrypts distribution data received from the multicast server 400 through the information transmitting/receiving section 220, by using the encryption key held by the encryption key management section 230. The encryption key management section 230 registers, updates, and deletes the encryption key distributed from the key management device 100. The information transmitting/receiving section 220 receives messages from the receiving terminals 10 and transmits cipher text encrypted by the encryption section 210.

Referring to FIG. 3, the following will describe an encryption key table held by the encryption key management section. In FIG. 3, an encryption key table 240 is made up of groups 241 and encryption keys 242. The encryption key table 240 is a table for matching the groups 241 and the encryption keys 242.

Referring to FIG. 4, the following will describe an encryption key/decoding key management table held by the table management section. In FIG. 4, an encryption key/decoding key management table 160 is made up of groups 161, encryption keys 162, sub groups 163, and decoding keys 164. The encryption key/decoding key management table 160 is a table for matching the groups 161, the encryption keys 162, the sub groups 163, and the encryption keys 164.

The following will describe a method of generating the encryption key. Data distributed by the multicast server 400 will be denoted as M. When the size of the distribution data is sufficiently large, the data may be divided into proper sizes so as to be processed by a computer as will be described below.

M is regarded as a numeric value and prime numbers larger than M are obtained. The number of obtained prime numbers is equal to the number of sub groups. When there are N sub groups, different prime numbers K1, K2, . . . , and Kn are prepared. An encryption key A is expressed as A=K1*K2* . . . *Kn where the prime numbers K1, K2, . . . , Kn are decoding keys. By using a polynomial equation (equation 6) having no constant terms for the encryption key A, cipher text X is created according to (equation 7).

f(A)=an·Ân+an−1·Â(n−1)+ . . . +a1·A (equation 6)

X=M+f(A) (equation 7)

where a coefficient ai (i=1, 2, . . . , n−1, n) is generated by a random number. The random number may be generated every time information is transmitted.

The receiving terminal 10 receives encryption information and decodes the information by using the decoding key of the sub group where the receiving terminal 10 belongs. The information is decoded with a remainder obtained by dividing the cipher text X by the decoding key. When the receiving terminal 10 belonging to a sub group 1 has the decoding key K1, (equation 8) is calculated.

X(mod K1)=M(mod K1)+f(A)(mod K1)=M(mod K1)+an·Ân(mod K1)+an−1·Â(n−1)(mod K1)+ . . . +a1·A(mod K1)=M(mod K1)=M (equation 8)

Since A=K1*K2* . . . *Kn is established, a remainder obtained by dividing f(A) by K1 is 0. K1 is a prime number larger than M and thus a remainder obtained by dividing M by K1 is M. Therefore, the original data M can be decoded from the cipher text X.

Referring to FIG. 5, the following will describe the creation of a sub group and the distribution of cipher text when a receiving terminal newly participates in the multicast group. In FIG. 5, the receiving terminal 10 newly participating in the multicast group transmits an IGMP join request to the multicast router 300 (S11). The multicast router 300 transmits the IGMP join request notification of the receiving terminal 10 to the key management device 100 in response to the message (S12). The key management device 100 checks whether or not the receiving terminal 10 belongs to the existing sub groups. When the receiving terminal 10 does not belong to any one of the sub groups, the key management device 100 creates a new sub group. The key management device 100 generates a decoding key for the generated sub group (S13). The key management device 100 changes the encryption key and distributes the changed encryption key to the seed node 200 (S14). The key management device 100 distributes the decoding key to the receiving terminal belonging to the newly generated sub group (S16).

The multicast server 400 distributes data to the seed node 200 (S17). The seed node 200 encrypts the distribution data received from the multicast server 400, by using the changed encryption key (S18). The seed node 200 distributes cipher text to the receiving terminals 10 belonging to the multicast group (S19). The receiving terminal 10 decodes the cipher text by using the decoding key having been distributed in step 16, and receives the data (S21).

In step 13, the number of sub groups is increased by one because the receiving terminal 10 has newly participated in the multicast group. The decoding key of the n+1-th sub group has a prime number Kn+1 larger than M. In this case, Kn+1 is a prime number different from K1, K2, . . . , and Kn. The encryption key A is changed to A′=K1*K2* . . . *Kn*Kn+1. The decoding keys have prime numbers K1, K2, . . . , Kn, and Kn+1 for the respective sub groups. By using a polynomial equation (equation 9) having no constant terms for the encryption key A′, cipher text X′ is determined according to (equation 10).

f(A′)=an+1·A′̂(n+1)+an·A′̂n+an−1·A′̂n+an −1·A′̂(n−1)+ . . . +a1·A′ (equation 9)

X′=M+f(A′) (equation 10)

where a coefficient ai (i=1, 2, . . . , n−1, n, n+1) is generated by a random number.

The cipher text is decoded with a remainder obtained by dividing the cipher text X′ by the decoding key. The receiving terminal having newly participated in the sub group decodes the cipher text by using the decoding key Kn+1 of the sub group where the receiving terminal belongs, as expressed in (equation 11).

X′(mod Kn+1)=M(mod Kn+1)+f(A′)(mod Kn+1)=M(mod Kn+1)+an+1·A′̂(n+1)(mod Kn+1)+an·An′̂n(mod Kn+1)+ . . . +a1·A′(mod Kn+1)=M(mod Kn+1)=M (equation 11)

The existing sub groups can similarly decode the cipher text without changing the decoding keys K1, K2, . . . , and Kn.

In step 16, the key is distributed from the seed node 200 to the receiving terminal 10 by using an Internet Key Exchange (IKE) protocol (RFC 2409), thereby improving security.

Referring to FIG. 6, the following will describe an encryption key processing sequence when a sub group is not newly generated by a newly joining receiving terminal. In FIG. 6, the receiving terminal 10 newly joining the multicast group transmits an IGMP join request to the multicast router 300 (S26). The multicast router 300 transmits the IGMP join request of the receiving terminal to the key management device 100 in response to the message (S27). The key management device 100 checks whether or not the receiving terminal belongs to the existing sub groups when receiving the IGMP join request notification of the receiving terminal (S28). When the receiving terminal belongs to one of the existing sub groups, the key management device 100 distributes, to the newly joining receiving terminal 10, a decoding key for the sub group where the receiving terminal belongs (S29).

Steps 31 to 34 are similar to steps 17 to 21 of FIG. 5 and thus the explanation thereof is omitted.

In the key management device 100, the newly joining receiving terminal 10 can decode the cipher text received from the seed node, without changing the encryption key and the decoding key.

Referring to FIG. 7, the following will describe the operation of the key management device when a receiving terminal newly joins the multicast group. In FIG. 7, the key management device 100 receives an IGMP join request notification from the newly joining receiving terminal (S501). The key management device 100 checks whether or not the newly participating receiving terminal 10 belongs to the existing groups (S502). When the receiving terminal 10 does not belong to any one of the existing sub groups (S502: NO), the key management device 100 creates a new sub group (S504). The key management device 100 generates a decoding key for the newly generated sub group (S505) and changes the encryption key (S506). The key management device 100 distributes the changed encryption key to the seed node (S507). Further, the key management device 100 distributes the generated decoding key to the newly joining receiving terminal (S508) and exits the process.

In step 502, when the receiving terminal 10 belongs to one of the existing sub groups (YES), the key management device 100 distributes, to the newly joining receiving terminal, a decoding key for the sub group where the receiving terminal belongs (S503), and exits the process.

Referring to FIG. 8, the following will describe the processing of an encryption key for the sub group which the receiving terminal has left. In FIG. 8, the multicast server 400 transmits distribution data to the seed node 200 (S31). The seed node 200 encrypts the received distribution data by using the encryption key A (S32). The seed node 200 transmits cipher text to the receiving terminal 10-2 and the receiving terminal 10-1 (S33, S34). The receiving terminal 10-2 and the receiving terminal 10-1 decode the received cipher text by using the decoding key K1 and receive the distribution data (S36, S37).

Assuming that the receiving terminal 10-1 leaves the multicast group, the leaving receiving terminal 10-1 transmits an IGMP leave notification to the multicast router 300 (S38). The multicast router 300 transmits the IGMP leave notification of the receiving terminal 10-1 to the key management device 100 in response to the message (S39). The key management device 100 receives the leave notification of the receiving terminal 10-1 and checks whether other receiving terminals remain in the sub group 510 which the receiving terminal 10-1 has left. In this case, other receiving terminals remain in the sub group 510 which the receiving terminal 10-1 has left. Thus a decoding key is updated only for the sub group which the receiving terminal 10-1 has left, and the encryption key is changed (S41). The key management device 100 distributes the changed encryption key to the seed node 200 (S42). The key management device 100 distributes the updated decoding key to the receiving terminal 10-2 remaining in the sub group which the receiving terminal 10-1 has left (S43).

The multicast server 400 transmits the distribution data to the seed node 200 (S46). The seed node 200 encrypts the distribution data received from the multicast server 400, by using the changed encryption key (A″) (S47). The seed node 200 distributes the encrypted cipher text to the receiving terminal 10-2 of the multicast group (S48). In this case, it is assumed that the distribution data is also received by the receiving terminal 10-1 having left the sub group (S49). The receiving terminal 10-2 decodes the cipher text by using the updated decoding key (S51) but the receiving terminal 10-1 having left the sub group does not have the updated decoding key and thus cannot decode the cipher text (S52).

When there are n sub groups, in response to the separation of the receiving terminal 10 having belonged to the sub group 1, the key management device 100 changes the decoding key K1 of the group 1 to a prime number K1″ that is different from K1, K2, . . . , Kn. The encryption key is changed from A=K1*K2* . . . *Kn to A″=K1″*K2* . . . *Kn. It is assumed that the decoding keys are set at prime numbers K1″, K2, . . . Kn that are obtained for the respective sub groups. By using a polynomial equation (equation 12) having no constant terms for the encryption key A″, cipher text X″ is determined according to (equation 13).

f(A″)=an·A″̂n+ . . . +a1·A″ (expression 12)

X″=M+f(A″) (expression 13)

where a coefficient ai (i=1, 2, . . . , n−1, n) is generated by a random number.

The cipher text is decoded with a remainder obtained by dividing the cipher text X″ by the decoding key. For the receiving terminal 10-2 remaining in the sub group 1 which the receiving terminal 10-1 has left, the cipher text is decoded using the decoding key K1″ as expressed in (equation 14).

X″(mod K1″)=M(mod K1″)+f(A″)(mod K1″)=M(mod K1″)+an·A″̂n(mod K1″)+ . . . +a1·A″(mod K1″)=M(mod K1″)=M (equation 14)

In the other unchanged sub groups, the cipher text can be similarly decoded without changing the decoding keys K2 to Kn.

The receiving terminal 10-1 having left the sub group 1 only has the decoding key K1, so that the cipher text is decoded as expressed in (equation 15).

X″(mod K1)=M(mod K1)+f(A″)(mod K1)=M(mod K1)+an·A″̂n(mod K1)+ . . . +a1·A″(mod K1)=M+an·A″̂n(mod K1)+an−1·A″̂(n−1)(mod K1)+ . . . +a1·A″(mod K1)≠M (equation 15)

Since A″=K1″*K2* . . . *Kn is established, f(A″) cannot be divided by K1, so that M is not obtained by (equation 15) and the cipher text cannot be decoded.

Referring to FIG. 9, the following will describe an encryption key processing sequence when the sub group is deleted in response to the separation of the receiving terminal from the sub group. In FIG. 9, the leaving receiving terminal 10 transmits an IGMP leave notification to the multicast router 300 (S61). The multicast router 300 transmits the IGMP leave notification of the receiving terminal 10 to the key management device 100 in response to the message (S62). The key management device 100 receives the leave notification of the receiving terminal 10 and checks whether other receiving terminals remain in the sub group which the receiving terminal 10 has left. In this case, since there are no other receiving terminals remaining in the sub group, the key management device 100 deletes the sub group and changes the encryption key (S63). The key management device 100 distributes the changed encryption key to the seed node 200 (S64).

In the case of n sub groups, when the receiving terminal that has belonged to the sub group 1 leaves the sub group 1 and there are no other receiving terminals remaining in the sub group 1, the number of sub groups is n−1. Assuming that the sub group 1 has the decoding key K1, the encryption key is changed from A=K1*K2* . . . *Kn to A′″=K2* . . . *Kn. The remaining n−1 sub groups keep holding the decoding keys K2 to Kn. By using a polynomial expression (equation 16) having no constant terms for the encryption key A′″, cipher text X′″ is determined according to (equation 17).

f(A′″)=an−1·A′″̂(n−1)+ . . . +a1·A′″ (equation 16)

X′″=M+f(A′″) (equation 17)

Referring to FIG. 10, the following will describe the processing of the key management device when the receiving terminal leaves the sub group. In FIG. 10, the key management device 100 receives an IGMP leave notification from the receiving terminal (S801). The key management device 100 checks whether other receiving terminals remain in the sub group which the receiving terminal has left (S802). When other receiving terminals remain in the sub group which the receiving terminal has left (YES), the key management device 100 updates the decoding key for the sub group which the receiving terminal has left (S803). The key management device 100 changes the encryption key (S804). The key management device 100 distributes the changed encryption key to the seed node 200 (S805). The key management device 100 distributes the updated decoding key to the receiving terminals remaining in the sub group which the receiving terminal has left (S806) and exits the process.

In step 802, when there are no other receiving terminals remaining in the sub group which the receiving terminal has left (NO), the key management device 100 deletes the sub group which the receiving terminal has left (S807). The key management device 100 changes the encryption key (S808). The key management device 100 distributes the changed encryption key to the seed node 200 (S809) and exits the process.

In the present embodiment, the function of the seed node can be incorporated into the multicast server and thus it is not necessary to provide the seed node. Further, the function of the key management device can be similarly incorporated into the multicast server.

According to the present embodiment, a key is updated only for a changed sub group, thereby reducing traffic for updating the key. Further, it is possible to efficiently multicast an encrypted broadcast message.

### Second Embodiment

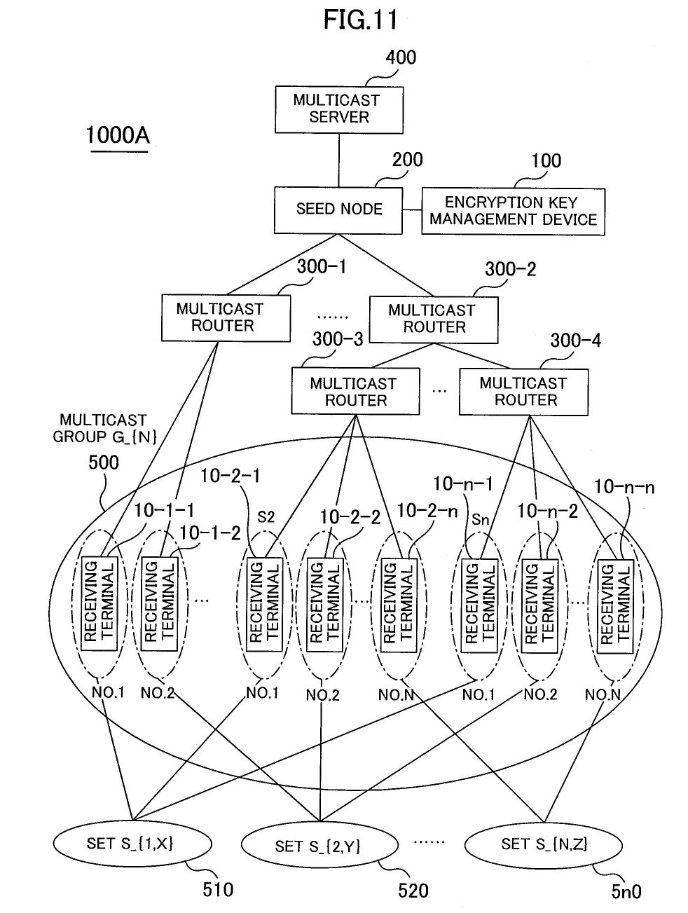

Referring to FIG. 11, a second embodiment will be described below. FIG. 11 is a hardware block diagram showing a multicast network.

In FIG. 11, a multicast network 1000A is made up of a multicast server 400, a seed node 200, a key management device 100, multicast routers 300, and receiving terminals 10. The configuration of the second embodiment is similar to that of the first embodiment. The second embodiment is characterized by a device for determining sub groups. As a method of determining the sub groups when a multicast group is divided into n sub groups, there are available: a method of randomly allocating the receiving terminals joining the multicast group to n sub groups, and a method of sequentially allocating the receiving terminals to the n sub groups. In another method, the maximum number of receiving terminals storable in a single sub group is set. In this case, when the number of receiving terminals exceeds the maximum number, another sub group is created to store the receiving terminals joining the multicast group.

FIG. 11 shows a method of sequentially allocating the receiving terminals 10 joining the multicast group 500 to the n sub groups. In FIG. 11, a multicast router 300-1 stores a receiving terminal 10-1-1 and a receiving terminal 10-1-2. A multicast router 300-2 stores a receiving terminal 10-2-1, a receiving terminal 10-2-2, and a receiving terminal 10-2-3. A multicast router 300-3 stores a receiving terminal 10-3-1, a receiving terminal 10-3-2, and a receiving terminal 10-3-3.

A sub group S_{1, X} 510 is made up of the receiving terminal 10-1-1, the receiving terminal 10-2-1, and a receiving terminal 10-n-1 which have been first registered in the multicast routers 300-1, 300-3, and 300-4. A sub group S_{2, Y} 520 is made up of the receiving terminal 10-1-2, the receiving terminal 10-2-2, and a receiving terminal 10-n-2 which have been second registered in the multicast routers 300-1, 300-3, and 300-4. A sub group S_(n, Z)5n0 is made up of a receiving terminal 10-2-n and a receiving terminal 10-n-n which have been n-th registered in the multicast routers 300-1, 300-3, and 300-4.

At this point, an encryption key and decoding keys are determined by the key management device 100. The multicast group has a single encryption key, whereas the number of decoding keys is equal to the number of sub groups. When a receiving terminal 10 newly joins the multicast group, the key management device 100 checks whether or not the newly joining receiving terminal belongs to the existing sub groups. When the receiving terminal 10 does not belong to any one of the existing sub groups, the key management device 100 creates a new sub group, generates a decoding key for the new sub group, and changes the encryption key. The key management device 100 distributes the changed encryption key to the seed node 200 and distributes the generated decoding key only to the new receiving terminal. In other words, only the encryption key and the decoding key for the new sub group are changed and the decoding keys for the other existing sub groups remain the same. When the newly joining receiving terminal belongs to one of the existing sub groups, the key management device distributes, to the newly joining receiving terminal, the decoding key for the sub group where the new receiving terminal belongs. In other words, the encryption key and the decoding keys are not changed.

When one of the receiving terminals 10 leaves the multicast group, the key management device 100 checks whether other receiving terminals remain in the sub group which the receiving terminal 10 has left. When there are other receiving terminals 10 remaining in the sub group which the receiving terminal has left, the key management device 100 updates the decoding key for the sub group which the receiving terminal has left, and changes the encryption key. The key management device 100 distributes the changed encryption key to the seed node 200 and distributes the updated decoding key to the receiving terminals 10 remaining in the sub group which the receiving terminal has left.

In other words, a change is made only to the encryption key and the decoding key for the sub group which the receiving terminal has left, and the decoding keys for the other sub groups remain the same. When there are no other receiving terminals 10 remaining in the sub group which the receiving terminal has left, the key management device 100 deletes the sub group which the receiving terminal has left, and changes the encryption key. In other words, only the encryption key is changed and the decoding keys for the other sub groups are not changed. Further, data is not transferred from the multicast router to the sub group deleted when the receiving terminal has left, so that the deleted sub group cannot receive the data.

According to the present embodiment, the receiving terminals of the multicast group can be freely divided into the sub groups.

### Third Embodiment

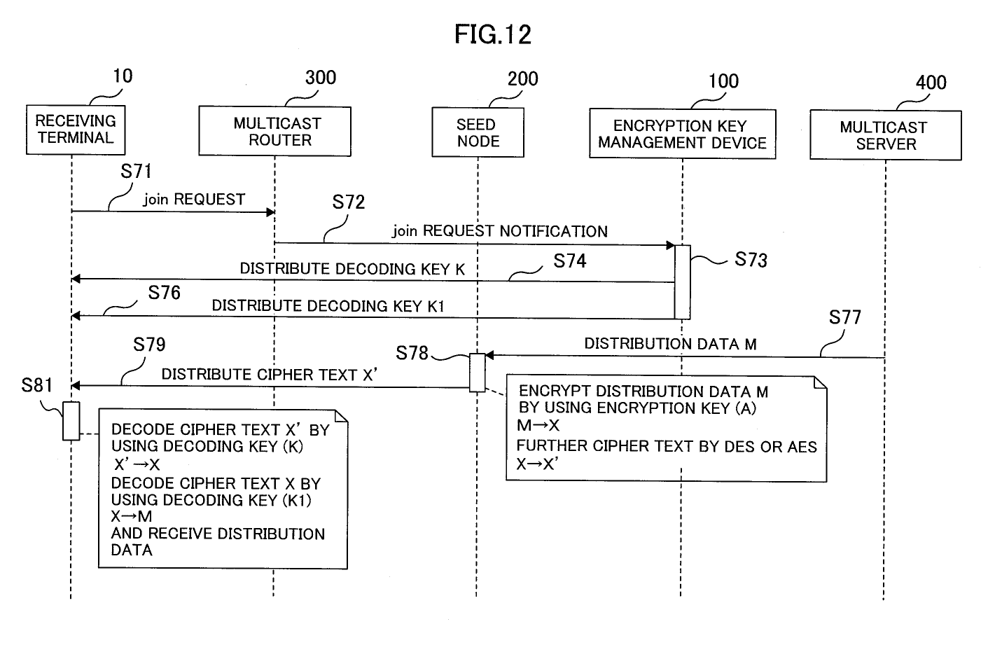

Referring to FIG. 12, a third embodiment will be described below. FIG. 12 is a sequence diagram showing a multicast network. When a multicast group has n sub groups, the sub groups has prime numbers K1, K2, . . . , Kn larger than a numeric value M representing data to be distributed from a multicast server. In the case of large data, the data may be divided into pieces of proper sizes and one of the divided pieces of data may be processed as M as will be described below. An encryption key A is expressed as A=K1*K2* . . . *Kn, the decoding key of a sub group 1 is denoted as K1, the decoding key of the sub group 2 is denoted as K2, and the decoding key of a sub group n is denoted as Kn. The number of decoding keys is equal to the number of sub groups.

Encryption is performed according to (equation 18).

X=M+A (equation 18)

where X is cipher text.

However, in order to protect the multicast group from others, it is necessary to achieve stronger encryption for cipher text X=M+A. Thus cipher text X=M+A is further encrypted by DES or AES and then is distributed. In this case, the decoding key of the cipher text encrypted by DES or AES is shared in the multicast group. The decoding keys are managed, updated, and distributed by the key management device.

Referring to FIG. 12, the following will describe a sequence of further encrypting cipher text X=M+A by DES and distributing the cipher text. In FIG. 12, a receiving terminal 10 newly joining the multicast group transmits an IGMP join request to a multicast router 300 (S71). The multicast router 300 transmits the IGMP join request of the receiving terminal to a key management device 100 in response to the message (S72). The key management device 100 distributes, to the receiving terminal 10, a decoding key for decoding the cipher text having been encrypted by DES (S73). The decoding key is denoted as K. The key management device 100 distributes a decoding key for the sub group where the receiving terminal 10 belongs (S74). The newly joining receiving terminal 10 belongs to the sub group 1 and receives the decoding key K1 of the sub group 1.

In this case, an encryption key management device 100 simultaneously distributes the decoding keys by using IKE. A multicast server 400 distributes distribution data M to a seed node 200 (S77). The seed node 200 receives the data M and encrypts the distribution data M into the cipher text X by using the encryption key A. Further, the seed node 200 encrypts the cipher text X into cipher text X′ by DES (S78). The seed node 200 transmits the cipher text X′ to the receiving terminal 10 of the multicast group (S79). The receiving terminal 10 receives the cipher text X′ and decodes the cipher text X′ by using the decoding key K distributed from the key management device 100. The cipher text X′ is decoded into X. Further, the receiving terminal 10 decodes the cipher text X by using the decoding key K1 of the sub group 1 and receives the distribution data M (S81).

### Fourth Embodiment

A fourth embodiment will be described below. In the fourth embodiment, data to be distributed from a multicast server 400 is denoted as M, the data M has a length of Lm=64 bits, and a multicast group has two sub groups. When two prime numbers larger than the data M are obtained, the lengths of prime numbers K1 and K2 are expressed as L1=64 bits and L2=64 bits, respectively. According to A=K1*K2, a length La of an encryption key A is expresses as La=L1*L2=128 bits. According to X=M+A, a length Lx of cipher text X is expressed as Lx=128 bits. The cipher text X is 64 bits longer than the actual distribution data M and the encryption key increases with the number of sub groups, leading to excessive communications.

The fourth embodiment will describe an encryption method in the case where the decoding key has an integer other than a prime number larger than multicast distribution data. Data to be distributed by the multicast server is denoted as M. Assuming that M is a numeric value, the decoding keys have integers K1, K2, . . . , Kn other than a prime number larger than M. K1, K2, . . . , Kn are integers which cannot be divided by one another. In the case of large data, the data may be divided into pieces of proper sizes and one of the divided pieces of data may be processed as M as will be described below.

The encryption key A is the least common multiple of K1, K2, . . . , Kn. The least common multiple is sufficiently large and K1, K2, . . . , Kn are made up of large prime numbers which are sufficiently hard to be factorized. As to the decoding keys, the decoding key of a sub group 1 is denoted as K1, the decoding key of a sub group 2 is denoted as K2, . . . , and the decoding key of a sub group n is denoted as Kn. The number of decoding keys is equal to the number of sub groups.

Encryption is performed according to (equation 19).

X=M+A (equation 19)

where X is cipher text.

The cipher text is decoded with a remainder obtained by dividing the cipher text X by the decoding key. In the case of the receiving terminal belonging to the sub group 1, the cipher text X is decoded by (equation 20).

X(mod K1)=M(mod K1)+A(mod K1)=M(mod K1)=M (equation 20)

where A is the least common multiple of K1, K2, . . . , Kn and thus a remainder obtained by dividing A by K1 is 0. Since M is smaller than K1, a remainder obtained by dividing M by K1 is M.

When a member leaves the sub group 2, the decoding key of the sub group 2 is changed to K2′ and an encryption key A′ is set at the least common multiple of K1′, K2′, . . . , Kn. Cipher text X′ is generated by (equation 21).

X′=M+A′ (equation 21)

As to the decoding keys, the new decoding key K2′ can be used but the former decoding key K2 cannot be used. Actually, even when the decoding key is changed, the sub group 1 is not affected by rekeying as expressed in (equation 22) and (equation 23).

X′(mod K2′)=M(mod K2′)+A′(mod K2′)=M(mod K2′)=M (equation 22)

X′(mod K1)=M(mod K1)+A′(mod K1)=M(mod K1)=M (equation 23)

Further, the receiving terminal which has left the sub group cannot decode the cipher text by using the former decoding key K2 as expressed in (equation 24).

X′(mod K2)=M(mod K2)+A′(mod K2)=M+A′(mod K2)≠M (equation 24)

Data to be distributed from the multicast server is denoted as M, the data M has a length of Lm=64 bits, and the multicast group has two sub groups. When two prime numbers larger than the data M are obtained, the lengths of the prime numbers K1 and K2 are expressed as L1=64 bits and L2=64 bits, respectively. In this case, the length La of the encryption key A is expressed as La=L1* L2=128 bits. The length Lx of the cipher text X is expressed as Lx=128 bits according to X=M+A.

In the case of two integers other than a prime number larger than the data M, the lengths of two integers K1′ and K2′ that cannot be divided by each other are expressed as L1′=64 bits and L2′=64 bits, respectively.

When the greatest common divider of the integers K1′ and K2′ is 32 bits, the encryption key A′ is the least common multiple of the integers K1′ and K2′ and thus the encryption key A′ has a length La′ of 96 bits. According to X′=M′+A′, a length Lx′ of the cipher text X′ is expressed as Lx′=96 bits. Thus the encryption method of the fourth embodiment can further reduce the cipher text X, achieving more efficient communications.

Practically X=M+A can only achieve weak encryption. Thus as in the first embodiment, the data is encrypted into X=M+f(A) by using a polynomial equation having no constant terms for the encryption key A as expressed below:

f(A)=an·Ân+an−1·Â(n−1)+ . . . +a1·A

where a coefficient ai (i=1, 2, . . . , n−1, n) is generated by a random number.

Further, as in the third embodiment, the cipher text X is further encrypted by DES or AES to achieve stronger encryption, and then the cipher text X is distributed.

What is claimed is:

1. A data distribution system comprising:
a distribution server that distributes data;
a node that encrypts the data from the distribution server and transmits the data to a plurality of receiving terminals; and
a key management device connected to the node to manage an encryption key of the node and decoding keys of the plurality of receiving terminals,
wherein the key management device allocates each of the receiving terminals to one of a plurality of sub groups and allocates the decoding keys to the respective sub groups, and the key management device changes, when receiving a leave notification from a first receiving terminal, the encryption key and a decoding key of a first sub group where the first receiving terminal belongs, and transmits the encryption key and the decoding key to the node and the other receiving terminals of the first sub group.

2. A key management device connected to a distribution server that distributes data and a node that encrypts the data from the distribution server and transmits the data to a plurality of receiving terminals, the key management device managing an encryption key of the node and decoding keys of the plurality of receiving terminals,
wherein the key management device allocates each of the receiving terminals to one of a plurality of sub groups and allocates the decoding keys to the respective sub groups, and
the key management device changes, when receiving a leave notification from a first receiving terminal, the encryption key and a decoding key of a first sub group where the first receiving terminal belongs, and transmits the encryption key and the decoding key to the node and the other receiving terminals of the first sub group.

3. The key management device according to claim 2,
wherein when M represents an amount of the data, prime numbers K1 and K2 larger than M are allocated to any of the sub groups as the decoding keys, and
the encryption key including a product of K1 and K2 is allocated to the node.

4. The key management device according to claim 3, wherein one of K1 and K2 and a second decoding key are transmitted to the receiving terminals.

5. A key management method of a data distribution system including a distribution server that distributes data, a node that encrypts the data from the distribution server and transmits the data to a plurality of receiving terminals, and a key management device connected to the node to manage an encryption key of the node and decoding keys of the plurality of receiving terminals,
the method comprising the steps of:
allocating each of the receiving terminals to one of a plurality of sub groups;
allocating the decoding keys to the respective sub groups;
changing the encryption key when receiving a leave notification from a first receiving terminal;
changing a decoding key of a first sub group where the first receiving terminal belongs; and
transmitting the changed encryption key to the node.

6. The key management method according to claim 5, further comprising the step of transmitting the changed decoding key to the other receiving terminals of the first sub group.
